(19) United States
(12) Patent Application Publication
(10) Pub. No.: US 2023/0135467 A1
(43) Pub. Date: May 4, 2023

(54) ELECTRIC IMPACT HAMMER

(71) Applicant: JIANGSU DONGCHENG TOOLS TECHNOLOGY CO., LTD., Nantong (CN)

(72) Inventor: Weiping HOU, Nantong (CN)

(21) Appl. No.: 18/088,787

(22) Filed: Dec. 27, 2022

Related U.S. Application Data
(63) Continuation of application No. PCT/CN2021/141924, filed on Dec. 28, 2021.

(30) Foreign Application Priority Data
Dec. 31, 2020 (CN) 202011632626.6

(51) Int. Cl. B25D 16/00; B25D 17/06; B25D 17/24; B25D 11/04

(52) U.S. Cl. CPC B25D 16/003; B25D 17/06; B25D 17/24; B25D 11/04; B25D 2217/0023; B25D 2250/095; B25D 2250/321; B25D 2250/351; B25D 2250/371

(57) ABSTRACT

An electric impact hammer includes an output shaft, a cylinder and a piston arranged in the cylinder. The piston defines an accommodating groove running through the rear end surface and a pair of through holes communicating with the accommodating groove and running through the outer periphery, and the front end of the output shaft is inserted in the accommodating groove, and the output shaft defines a corrugated groove on the outer periphery of the front end and a steel ball partially accommodated in the corrugated groove, the corrugated groove is connected end to end along the outer periphery of the output shaft and has an axial front end and an axial rear end; the other part of the steel ball is accommodated in the through hole, and the output shaft drives the piston to reciprocate in the axial direction by means of the steel balls.

### CROSS REFERENCE TO RELATED APPLICATIONS

The present disclosure is a continuation-application of the International Patent Application No. PCT/CN2021/141924, filed on Dec. 28, 2021, which claims the priority of the Chinese Patent Application No. 202011632626.6, filed on Dec. 31, 2020, and the contents of which are hereby incorporated in their entireties.

### TECHNICAL FIELD

The present invention relates to the field of electric tools, in particular to an electric impact hammer used for drilling or chiseling on concrete, floor slabs, brick walls and stone materials.

### BACKGROUND

A traditional electric impact hammer is arranged with a mechanism of a crank connecting rod or a pendulum rod bearing to drive a piston to reciprocate, such that the impact hammer in the cylinder is driven by the piston to perform an impact output.

Please refer to the Chinese Invention Patent No. CN101312807B of Bosch Co., Ltd., which discloses an electric hammer. The electric hammer drives an intermediate shaft to rotate through a motor. The intermediate shaft is arranged parallel to the lower part of the motor and provided with a pendulum rod bearing and a rotary input gear, and the intermediate shaft drives a pendulum rod of the pendulum rod bearing to swing and drives a piston in a cylinder to reciprocate. The cylinder is fixed with a driving gear which meshes with the rotary input gear, and the rotary input gear drives the cylinder to rotate together through the driving gear. However, the volume of the electric hammer is increased by means of impact driven by the pendulum rod bearing, meanwhile the weight of the pendulum rod bearing is relatively large. Please refer to Chinese Patent No. CN2860757Y of Zhejiang Haiwang Electric Co., Ltd., which discloses an electric hammer, wherein the electric hammer has a motor, which is perpendicular to a cylinder and arranged below the cylinder. The motor drives an eccentric shaft to rotate, and the eccentric shaft drives a piston to reciprocate through a connecting rod. The piston pushes the electric hammer for impact output, but the electric hammer needs to make more space to accommodate the structure of the crank connecting rod, in addition, the weight of the crank connecting rod is relatively large.

Therefore, it is desired to provide a new impact electric hammer for reducing the volume and weight of the impact electric hammer.

### SUMMARY OF THE INVENTION

In order to solve the above problems, the present disclosure provides a miniaturized electric impact hammer.

To achieve the above-mentioned object, an impact electric hammer comprises a housing, a motor retained in the housing, and an impact assembly and a rotating assembly driven by the motor. The rotating assembly includes an output shaft connected to the front end of the motor and a cylinder driven by the output shaft, the motor drives the output shaft to drive the cylinder to rotate. The impact assembly includes a piston slidably arranged in the cylinder, the piston slides back and forth along the inside of the cylinder, and the cylinder drives the piston to rotate together. The piston is provided with an accommodating groove running through the rear end surface and a pair of through holes communicating with the accommodating groove and running through the outer periphery, the front end of the output shaft is inserted in the accommodating groove and provided with a corrugated groove located in the front end of the outer periphery, the corrugated groove is connected end to end along the outer periphery of the output shaft and has an axial front end and an axial rear end. The impact assembly includes a steel ball partially accommodated in the corrugated groove, the other part of the steel ball is accommodated in the through hole, when the output shaft rotates, the steel ball moves between the axial front end and the axial rear end of the corrugated groove to drive the piston to reciprocate along the axial direction.

### BRIEF DESCRIPTION OF THE DRAWINGS

FIG. 1 is a cross-sectional view of an electric impact hammer of the present disclosure, wherein a piston of the electric impact hammer is arranged at a rear end position;

FIG. 2 is a cross-sectional view of the electric impact hammer of FIG. 1, wherein the piston of the impact electric hammer is arranged at a front end position;

FIG. 3 is an enlarged view of a portion of the electric impact hammer of FIG. 1;

FIG. 4 is a cross-sectional view of a motor and a planetary gear assembly of the electric impact hammer of FIG. 1;

FIG. 5 is a perspective view of a portion of the planetary gear assembly of FIG. 4;

FIG. 6 is a perspective view of a cylinder, a clutch assembly and a portion of a planetary gear assembly of an electric impact hammer of the present invention;

FIG. 7 is a cross-sectional view of a cylinder sleeve assembly and a clutch assembly of the electric impact hammer of FIG. 1;

FIG. 8 is a cross-sectional view of the cylinder and a transmission sleeve of the electric impact hammer of FIG. 7;

FIG. 9 is a perspective view of a cylinder of an electric impact hammer of the present disclosure;

FIG. 10 is a front view of a piston of an electric impact hammer of the present disclosure.

### DETAILED DESCRIPTION

The embodiments of the present disclosure are further described below by referring to the accompanying drawings and examples.

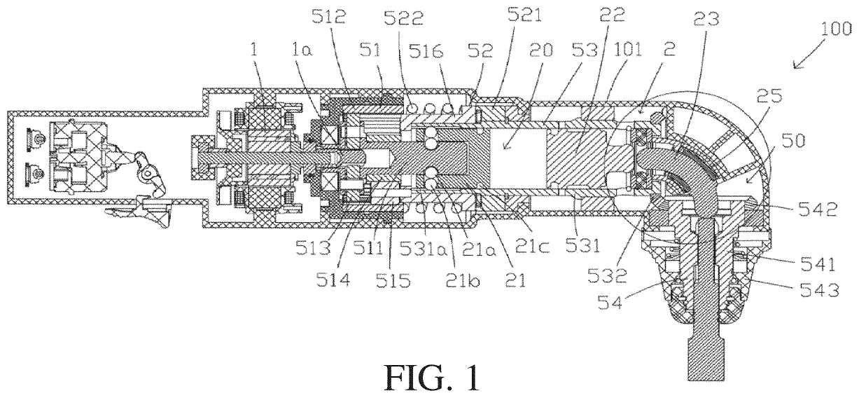

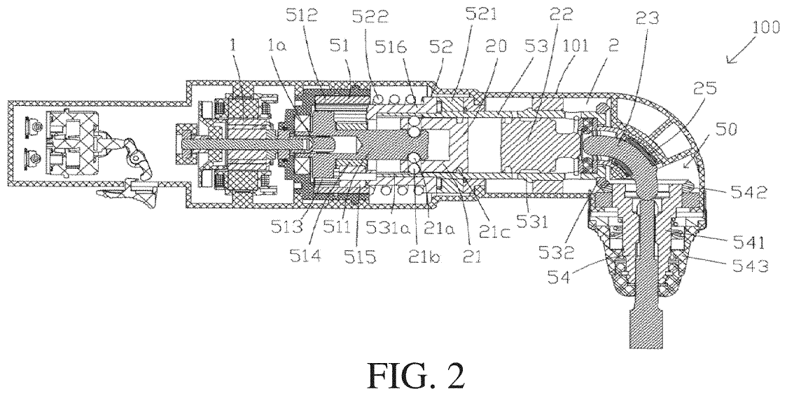

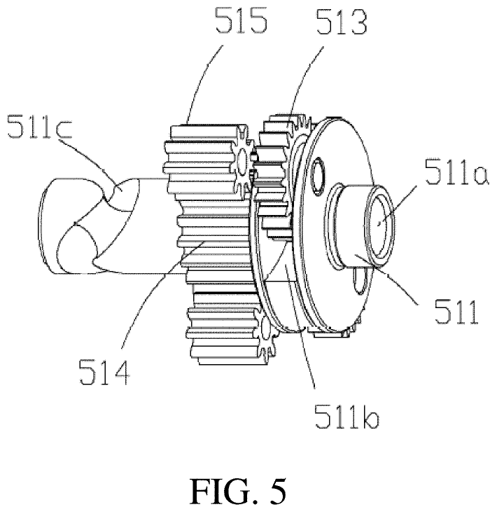

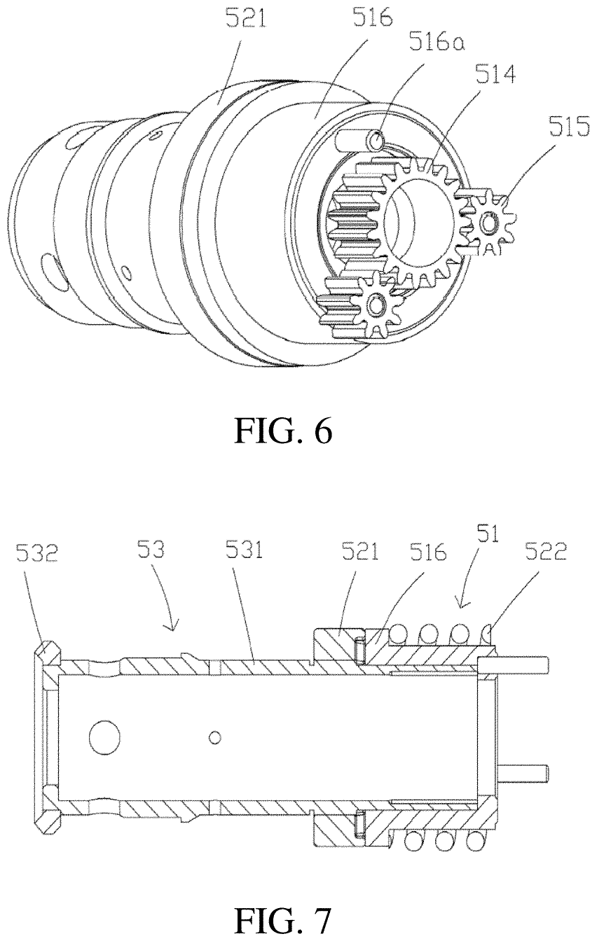

Reference to FIGS. 1 to 10, the present disclosure provides an electric impact hammer 100. In the present disclosure, a direction parallel to an output direction of a motor 1 of the electric impact hammer 100 is defined as a front-rear direction. The impact hammer 100 includes a housing 101 extending along the front-rear direction, a motor 1 received in the housing 101, a drive assembly 2 driven by the motor 1, and a chisel head detachably mounted at an end of the drive assembly 2. The drive assembly 2 is received in the housing 101 and includes an impact assembly 20 and a rotating assembly 50, the motor 1 drives the impact assembly 20 to compress air, such that the impact assembly 20 is ejected to impact the chisel head to perform an impact output. The motor 1 drives the rotary assembly 50 to drive the chisel head to perform a rotary output.

The rotating assembly 50 includes a planetary gear assembly 51, a clutch assembly 52, a cylinder sleeve assembly 53 and a rotating sleeve assembly 54, and the planetary gear assembly 51, the clutch assembly 52, the cylinder sleeve assembly 53, and the rotating sleeve assembly 54 are in transmitted connection to a front end of the motor 1. The motor 1 is arranged with a motor shaft 1a extending in the front-rear direction, the front end of the motor shaft 1a is engaged with the planetary gear assembly 51. The clutch assembly 52 is in transmitted connection to a front of the planetary gear assembly 51, sleeves the cylinder sleeve assembly 53, and drives the cylinder sleeve assembly 53 to rotate together with the clutch assembly 52.

The electric impact hammer 100 in the present embodiment is an electric angular impact hammer, which defines the output direction of the chisel head of the electric impact hammer 100 to be a downward direction. The rotary sleeve assembly 54 is in transmitted connection to a lower part of a front end of the cylinder sleeve assembly 53. The rotary sleeve assembly 54 is perpendicular to the cylinder sleeve assembly 53, and is extending downwardly toward an outside of the housing 101. The chisel head is accommodated in the rotary sleeve assembly 54 and rotates together with the rotating sleeve assembly 54.

Reference to FIGS. 1 and 7, the cylinder sleeve assembly 53 includes a cylinder 531 extending along the front-rear direction and an input gear 532 sleeving a front end of the cylinder 531. The input gear 532 is fixed on the cylinder 531 and rotates together with the cylinder 531. The cylinder 531 is supported in the housing 101 by two bearings, which are fixed at the front and rear and are spaced apart from each other.

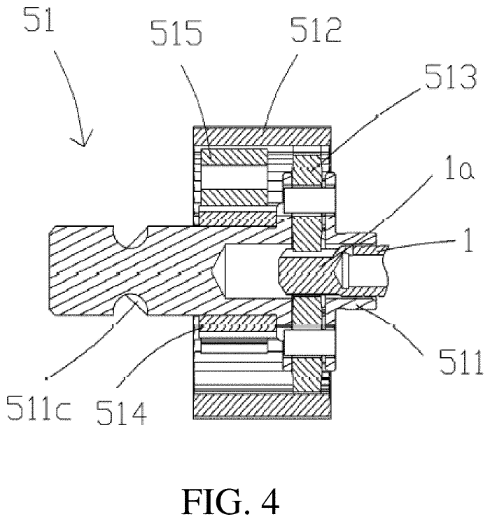

Reference to FIGS. 4 to 6, the planetary gear assembly 51 includes an output shaft 511, an inner ring gear 512, a plurality of a first planetary gears 513, a sun gear 514, a plurality of a second planetary gears 515, and a planetary carrier 516. The output shaft 511 extends along the front-rear direction. A rear end of the output shaft 511 is supported in the housing 101 by a bearing, and a front end of the output shaft 511 is supported on an inner wall of the cylinder 531. The inner ring gear 512 is fixedly arranged in the housing 101, and an inner wall of the inner ring gear 512 engages with the first planetary gear 513.

The output shaft 511 defines a receiving groove 511a running through a rear end surface of the output shaft 511 and is arranged with a plurality of mounting seats 511b communicating with the receiving groove 511a and running through an outer periphery of the output shaft 511. In the present embodiment, the output shaft 511 is provided with two mounting seats 511b in the circumferential direction. The front end, in an axial direction, of the motor shaft 1a is inserted into the receiving groove 511a, and two first planetary gears 513 are connected with the mounting seats 511b in relative rotation and engage with the motor shaft 1a received in the receiving groove 511a, the motor shaft 1a drives the output shaft 511 to rotate via the first planetary gear 513.

The sun gear 514 is disposed at a front of the first planetary gears 513 and fixed on the output shaft 511, so that the sun gear 514 and the output shaft 511 rotate together. In the present embodiment, the sun gear 514 and an outer ring of the output shaft 511 are in interference fit with each other. In other embodiments, the sun gear 514 may alternatively be integrally formed with the output shaft 511. Two sides of each second planetary gear 515 are respectively engaged with the sun gear 514 and the inner ring gear 512. The planetary carrier 516 sleeves an outer periphery of the rear end of the cylinder 531, and the output shaft 511 runs through the planetary carrier 516 and extends into the cylinder 531. The rear end of the planetary carrier 516 is provided with three pins 516a. The three pins 516a are fixedly inserted into the rear end of the planetary carrier 516 and are running through and supporting the second planetary gears 515. The second planetary gear 515 drives the planetary carrier 516 to rotate together with the second planetary gear 515 via the pins 516a.

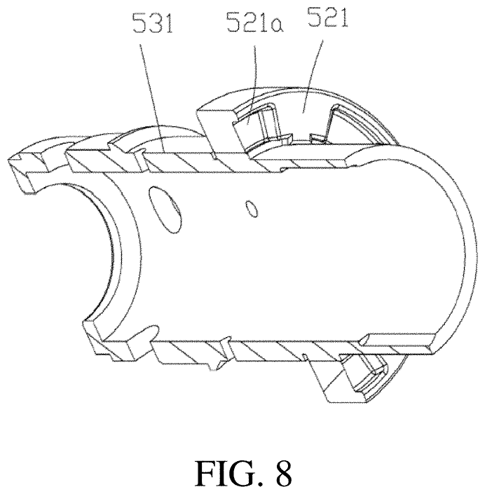

Refer to FIG. 1, FIG. 7 and FIG. 8, the clutch assembly 52 includes a spring 522 and a transmission sleeve 521 sleeving the outer periphery of the cylinder 531, the transmission sleeve 521 and the cylinder 531 are connected by a keyway and rotate together, and a front end of the drive sleeve 521 abuts against a rear bearing supporting the cylinder 531. The front end of the planetary carrier 516 is engaged with the rear end of the transmission sleeve 521, and that is, each of the front end surface of the planetary carrier 516 and the rear end surface of the transmission sleeve 521 has a concave-convex structure 521a, so that the front end surface of the planetary carrier 516 and the rear end surface of the transmission sleeve 521 can engage with each other through the concave-convex structure 521a.

The spring 522 sleeves the planetary carrier 516. A front end of the spring 522 is pressed against the planetary carrier 516, and a rear end of the spring 522 abuts against the housing 101. The planetary carrier 516 has an annular step located at the rear end and abutting against the cylinder 531, such that the spring 522 pushes the cylinder 531 forwardly.

When the impact electric hammer 100 is working under normal load, the planetary carrier 516 drives the cylinder 531 to rotate via the transmission sleeve 521. When the impact electric hammer 100 is overloaded, the cylinder 531 and the transmission sleeve 521 stop rotating, and the planetary carrier 516 overcomes a pressure of the spring 522 and disengages from the engagement of the transmission sleeve 521. In this way, transmission of the motor 1 may be separated from rotation of the cylinder 531 when the electric impact hammer 100 is overloaded, preventing the motor from burning.

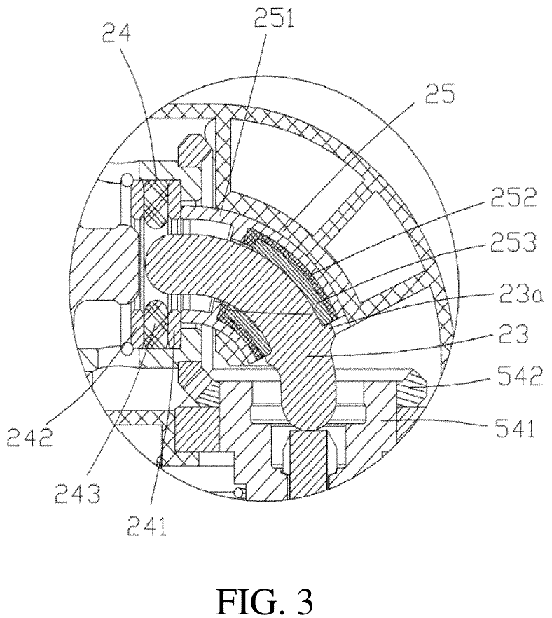

As shown in FIGS. 1 and 3, the rotating sleeve assembly 54 includes a rotating sleeve 541, an output gear 542 fixed on the rotating sleeve 541, and a clamping assembly 543 fixed on the rotating sleeve 541. The rotating sleeve 541 is arranged on the front end of the housing 101 and is perpendicular to the cylinder 531. The clamping assembly 543 is configured to clamp the chisel head. The output gear 542 is fixed on an upper end of the rotating sleeve 541 and engaged with the input gear 532, the input gear 532 drives the rotating sleeve 541 to rotate together with the input gear 532 via the output gear 542.

As shown in FIGS. 1 to 5, the impact assembly 20 includes a piston 21, a plurality of steel balls 21a, a hammer 22, an impact rod 23, a lock hammer assembly 24, a corner support assembly 25, and the above-mentioned cylinder 531. The piston 21, the hammer 22, and the lock hammer assembly 24 are arranged on the inner wall of the cylinder 531 successively from the rear to the front of the cylinder 531. The piston 21 defines an accommodating groove, which is running through a rear end surface of the piston 21, and a pair of through holes, which are communicating with the accommodating groove and running through an outer periphery of the piston 21. Meanwhile, a part of each steel ball 21a is accommodated in the corresponding through hole.

The front end of the output shaft 511 is inserted into the accommodating groove, and the output shaft 511 defines a corrugated groove 511c disposed on the outer periphery of the front end of the output shaft 511. The corrugated groove 511c is connected end to end along the output periphery of the shaft 511 and has an axial front end and an axial rear end. The other part of each steel ball 21a is accommodated in the corrugated groove 511c. The piston 21 is clamped in the corrugated groove 511c by the steel ball 21a and can slide between the axial front end and the axial rear end of the corrugated groove 511c. One of an outer wall of the piston 21 and the inner wall of the cylinder 531 defines a slot, and the other of the outer wall of the piston 21 and the inner wall of the cylinder 531 is provided with a protrusion clamped in the slot, so that the piston 21 and the cylinder 531 rotate synchronously.

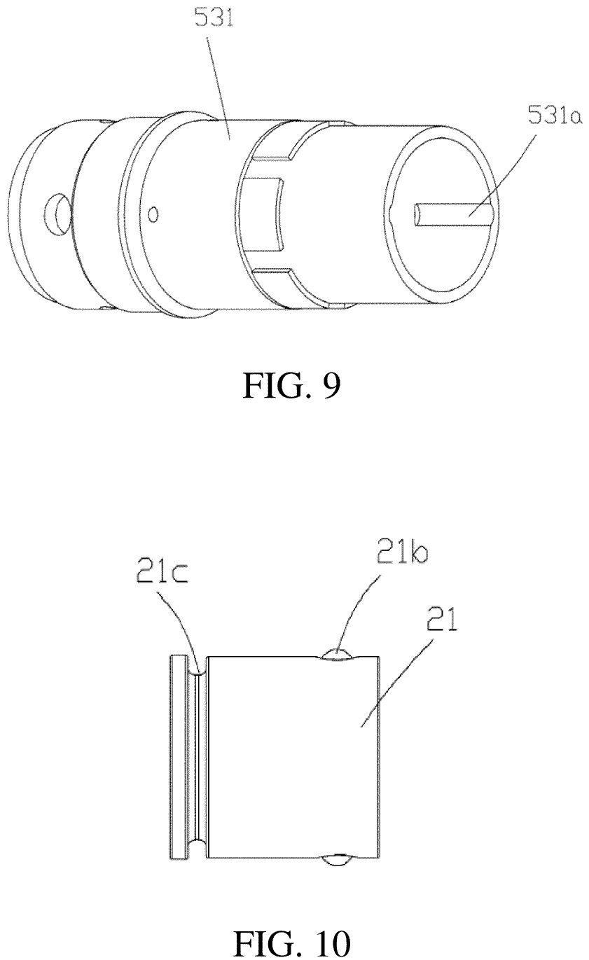

Reference to FIGS. 9 to 10, in this embodiment, the inner wall of the cylinder 531 defines a pair of slots 531a extending axially and forwardly from the rear end of the inner wall of the cylinder 531. The outer periphery of the piston 21 is provided with a pair of protrusions 21b, and each of the pair of protrusions 21b engages with one of the pair of slots 531a. The piston 21 is clamped in the cylinder 531 by the protrusions 21b and rotates synchronously with the cylinder 531. Each protrusion 21b is further a ball accommodated in the through hole of the piston 21. A lower end of each protrusion 21b abuts against the corresponding steel ball 21a, and an upper end of the protrusion 21b is accommodated in the corresponding slot 531a. In the present embodiment, the ball is clamped by the corresponding slot 531a, and a rolling friction is generated instead of a sliding friction, allowing wear on the cylinder 531 to be reduced.

A rotation speed of the output shaft 511 is set to be S1, the planetary gear assembly 51 decelerates the rotation speed S1 of the output shaft 511 to obtain a rotation speed S2 of the planetary carrier 516 and the cylinder 531, and the rotation speed S1 is greater than the rotation speed S2. A speed difference between the rotation speed of the output shaft 511 and the rotation speed of the cylinder 531 causes the corrugated groove 511c on the output shaft 511 to continuously drive the piston 21 to reciprocate, such that the piston 21 compresses the air to drive the hammer 22 to impact.

The hammer 22 transmits the impact force to the impact rod 23, and the impact rod 23 drives the chisel head to perform the impact output.

In the present embodiment, the piston 21 has a sliding portion abutting against the inner wall of the cylinder 531, the sliding portion defines an annular groove 21c recessed inwardly, and the impact assembly 20 is provided with a sealing ring received in the annular groove. The sealing ring abuts against the inner wall of the cylinder to increase air tightness. The protrusion 21b and the slot 531a are both located on a rear side of the sealing ring and the annular groove 21c when the piston 21 is at the rearmost end of the a moving trace of the piston 21, preventing the compressed air from leaking out of the slot, such that better air tightness is achieved, and the impact force of the electric impact hammer 100 is increased.

The cylinder 531 is provided with a step, which is protruding inward from the inner wall of the front end, and an elastic collar, which is located at the rear side of the step and retained in the inner wall. The lock hammer assembly 24 is axially limited between the step and the elastic collar. The lock hammer assembly 24 includes a front washer 241 abutting against the step, a rear washer 242 abutting against the elastic collar, and a rubber ring 243 disposed between the front washer 241 and the rear washer 242. The hammer 22 has a large-diameter portion abutting against the inner wall of the cylinder 531 and a small-diameter portion located at the front end of the large-diameter portion and configured to impact the impact rod 23. The front end of the small-diameter portion is provided with an annular protrusion, a diameter of the protrusion is larger than an inner diameter of the rubber ring 243. When the electric impact hammer 100 is in an unloaded state, the piston 21 drives the hammer 22 to move forwardly, and the annular protrusion is clamped at the front end of the rubber ring 243 and can no longer slide backwardly.

As shown in FIG. 3, the impact rod 23 is arc-shaped and reciprocates along the front -rear direction between the cylinder 531 and the rotating sleeve 541. The corner support assembly 25 sleeves the impact rod 23 and is supported in the housing 101. The corner support assembly 25 includes a support sleeve 251 in the shape of an arc tube, a damping ring 252, and a sliding sleeve 253. The support sleeve 251 is directly supported in the housing 101. The rear end of the support sleeve 251 abuts against a front washer 241, and the front end of the support sleeve 251 abuts against the housing 101. That is, the support sleeve 251 abuts on the cylinder 531 via the lock hammer assembly 24.

The damping ring 252 is fixed on the inner wall of the support sleeve 251 and extends along the arc-shaped inner wall of the support sleeve 251. The inner wall of the support sleeve 251 is provided with a blocking wall that protrudes inwardly and abuts against the rear end of the damping ring 252 to prevent the damping ring 252 from sliding to the rear end of the support sleeve 251. The sliding sleeve 253 is fixedly held in the damping ring 252, the sliding sleeve 253 sleeves the impact rod 23, and the impact rod 23 slides clockwise or counter-clockwise along the inner wall of the sliding sleeve 253. When the small-diameter portion of the hammer 22 impacts the impact rod 23, the impact rod 23 slides clockwise along the inner wall of the sliding sleeve 253, the rear end of the impact rod 23 is intermittently inserted into the cylinder 531, and the front end of the impact rod 23 is intermittently inserted into the rotary sleeve 541 to impact the chisel head.

The impact rod 23 is provided with a convex part 23a protruding outwardly from a periphery of the front end of the convex part 23a. When the impact rod 23 slides counter-clockwise, the convex portion 23a is clamped in the end surface of the sliding sleeve 253 and does not contact the damping ring 252. The convex portion 23a transmits a reverse impact force of the impact rod 23 to the sliding sleeve 253. The shock-absorbing ring 252 is an arc-shaped rubber sleeve, and the damping ring 252 buffers the impact force applied on the sliding sleeve 253 and transfers the impact force to the support sleeve 251. That is, the damping ring 252 performs a first-stage shocking absorption.

The support sleeve 251 transmits the impact force to the front washer 241, and the impact force on the front washer 241 is buffered by the rubber ring 24 and then transferred to the rear washer 242. Further, the rear washer 242 transmits the impact force to the cylinder 531 via the elastic collar. That is, the rubber ring 24 performs a second-stage shocking absorption. The rear end of the planetary carrier 516 is provided with an annular step abutting against the cylinder 531, and the cylinder 531 transmits the impact force to the planetary carrier 516, the spring 522 buffers the impact force transmitted to the planetary carrier 516 and then transmits the impact force to the housing 101. That is, the spring 522 performs a third-stage shocking absorption.

In the present embodiment, the reverse impact force of the impact rod 23 may be buffered by three stages shocking absorption cumulatively, such that the impact electric hammer 100 may be operated more comfortably. In other embodiments, the third-stage shocking absorption may alternatively achieved by arranging a clamp spring in the front end of the planetary carrier 516. The clamp spring is clamped on the outer ring of the cylinder 531, and the cylinder 531 transmits the impact force to the planetary carrier 516 via the clamp spring, such that the spring 522 buffers the impact force of the planetary carrier 516 and transfers the impact force to the housing 101. In another manner, the support sleeve 251 may be omitted, and the damping ring 252 may be directly supported in the housing 101, and the damping ring 252 m directly abut against the front washer 241.

In the present disclosure, the output shaft 511 of the electric impact hammer 100 is inserted into the accommodating groove of the piston 21, the outer periphery of the piston 21 defines a pair of through holes running through the outer periphery and reaching the accommodating groove. The outer periphery of the front end of the output shaft 511 defines the corrugated groove 511c, the steel ball 21a is clamped between the through hole and the corrugated groove 511c. The steel ball 21a moves between the axial front end and the axial rear end of the corrugated groove 511c when the output shaft is rotating, such that the steel ball 21a drives the piston 21 to reciprocate in the axial direction. The mechanism configured to drive the piston 21 to reciprocate is concentratively arranged inside the piston 21, such that the electric impact hammer 100 has a compact and miniaturized structure. In addition, the traditional crank connecting rod and the pendulum rod bearing having a large weight are omitted in the present disclosure, the weight of the electric impact hammer 100 is reduced significantly.

The output shaft 511 is in transmitted connection to the front of the motor 1, the output shaft 511 is connected with the planetary carrier 516, the planetary carrier 516 sleeves the rear end of the cylinder 531, and the output shaft 511 runs through the planetary carrier 516 and drives the planetary carrier 516 to drive the cylinder 531 to rotate synchronously. The motor 1, the output shaft 511, and the cylinder 531 have a same axis of rotation, which makes the structure of the hammer 100 more compact and miniaturized. The impact electric hammer 100 becomes more compact, and the housing 101 can also be configured into a sleeve shape that is convenient for the operator to hold, changing the way that a handle of the impact hammer must be held from the rear end of the impact electric hammer 100.

The damping ring 252 retained in the corner support assembly 25, the rubber ring 243 of the lock hammer assembly 24 retained in the front end of the cylinder 531, and the spring 522 sleeving the outer periphery of the cylinder 531 accumulatively performs three stages of shocking absorption, effectively reducing the vibration of the impact electric hammer 100 and improving the operating comfort of the operator. At the same time, hard collision applied to internal components of the electric impact hammer 100 may be reduced, and the service life of the electric impact hammer 100 may be increased.

Although the present invention has been described with reference to particular embodiments, it is not to be construed as being limited thereto. Various alterations and modifications can be made to the embodiments without in any way departing from the scope or spirit of the present invention as defined in the appended claims.

What is claimed is:

1. An electric impact hammer, comprising:
a housing, extending along a front -rear direction;
a motor, received in the housing;
a rotating assembly, driven by the motor and comprising an output shaft connected to a front end of the motor and a cylinder driven by the output shaft, the motor driving the output shaft to drive the cylinder to rotate; and
an impact assembly, driven by the motor and comprising a piston slidably arranged inside the cylinder, the piston sliding inside the cylinder along the front-rear direction, and the cylinder driving the piston to rotate together with the cylinder;
wherein the piston defines an accommodating groove running through a rear end surface of the piston and a pair of through holes communicating with the accommodating groove and running through an outer periphery of the piston, a front end of the output shaft is inserted in the accommodating groove;
wherein the output shaft defines a corrugated groove located on an outer periphery of the front end of the output shaft; two ends of the corrugated groove, along the outer periphery of the output shaft, are connected to each other; the corrugated groove has an axial front end and an axial rear end;
wherein the impact assembly comprises a pair of steel balls, a part of each of the pair of steel balls is partially accommodated in the corrugated groove, the other part of each of the pair of steel balls is accommodated in a corresponding one of the pair of through holes; and when the output shaft is rotating, the pair of steel balls move between the axial front end and the axial rear end of the corrugated groove to drive the piston to reciprocate in the front-rear direction.

2. The electric impact hammer as claimed in claim 1, wherein one of an outer wall of the piston and an inner wall of the cylinder defines at least one slot parallel to an axial direction of the cylinder, and the other of the outer wall of the piston and the inner wall of the cylinder is arranged with at least one protrusion clamped in the at least one slot correspondingly.

3. The electric impact hammer as claimed in claim 2, wherein the piston is arranged with a sliding portion abutting against the inner wall of the cylinder and an annular groove recessed inwardly from the sliding portion, the impact assembly comprises a sealing ring received in the annular groove, and the sealing ring abuts against the inner wall of the cylinder; and each of the at least one protrusion and the at least one slot is located on a rear side of the sealing ring and the annular groove when the piston is disposed at a rearmost end of a movement trace of the piston.

4. The electric impact hammer as claimed in claim 3, wherein the slot is extending forwardly starting from a rear end of the inner wall of the cylinder, each of the at least one protrusion is a ball received in the corresponding through hole of the piston, and a lower end of the at least one protrusion abuts against a corresponding one of the pair of steel balls, and an upper end of the at least one protrusion is received in the corresponding slot.

5. The electric impact hammer as claimed in claim 1, wherein the rotating assembly comprises a planetary gear assembly connected to a front end of the motor, the planetary gear assembly comprises an inner ring gear fixed in the housing and a plurality of first planetary gears meshing with an inner wall of the inner ring gear.

6. The electric impact hammer as claimed in claim 5, wherein the output shaft defines a receiving groove running through a rear end surface of the output shaft and a mounting seat communicating with the receiving groove and running through an outer periphery of the output shaft, the motor is arranged with a motor shaft extending into the receiving groove, and a plurality of the first planetary gears are arranged in the mounting seat and engaged with the motor shaft.

7. The electric impact hammer as claimed in claim 6, wherein the planetary gear assembly comprises a sun gear retained in the output shaft, a plurality of second planetary gears, and a planetary carrier meshed with the sun gear, the sun gear is located in front of the first planetary gears and the mounting seat, the planetary carrier is arranged with a plurality of pins located at a rear end of the planetary carrier, each of the plurality of second planetary gears is supported on a corresponding one of the plurality of pins and meshes with the inner ring gear, and the output shaft rotates together with the planetary carrier via the second planetary gears, the planetary carrier sleeves a rear end of the cylinder and drives the cylinder to rotate synchronously.

8. The electric impact hammer as claimed in claim 7, wherein the rotating assembly further comprises a spring sleeving the planetary carrier and a transmission sleeve sleeving an outer periphery of the cylinder, the transmission sleeve is located in front of the planetary carrier, and the transmission sleeve is connected with the cylinder via a keyway.

9. The electric impact hammer as claimed in claim 8, wherein a front end of the spring is pressed against the planetary carrier, and a rear end of the spring abuts against the housing, and the planetary carrier is pushed to be engaged with a rear end of the transmission sleeve, and the planetary carrier is configured to be capable of rotating together with the cylinder via the transmission sleeve.

10. The electric impact hammer as claimed in claim 1, wherein the rotating assembly comprises a rotating sleeve assembly that is arranged on the front end of the cylinder and is perpendicular to the cylinder; the rotating sleeve assembly comprises a rotating sleeve and an output gear fixed on the rotating sleeve; and the rotating assembly further comprises an input gear fixed on the front end of the cylinder, and the input gear meshes with the output gear.

11. The electric impact hammer as claimed in claim 10, wherein the impact assembly further comprises an arc-shaped impact rod and a corner support assembly sleeving the impact rod, the impact rod is located between the cylinder and the rotating sleeve, the corner support assembly comprises a sliding sleeve sleeving an outside of the impact rod and is supported in the housing, the impact rod slides clockwise or counter-clockwise along the inner wall of the sliding sleeve.

12. The electric impact hammer as claimed in claim 11, wherein the impact rod is arranged with a convex portion protruding outwardly from an outer periphery of a front end of the impact rod, and the convex portion is clamped in an end face of the sliding sleeve when the impact rod slides counter-clockwise.

13. An electric impact hammer comprising:
a housing, extending along a front -rear direction;
a motor, received in the housing;
a rotating assembly, driven by the motor and comprising a planetary gear assembly,
a cylinder sleeve assembly, and a rotary sleeve assembly, wherein the motor drives the planetary gear assembly to rotate; and
wherein the planetary gear assembly comprises an output shaft pivotally connected with the motor and a planetary carrier sleeving the output shaft, the output shaft and the planetary carrier mesh with each other through gears, and the output shaft defines a corrugated groove located on an outer periphery of a front end of the output shaft and a pair of steel balls each partially received in the corrugated groove, each of the pair of steel ball moves between an axial front end and an axial rear end of the corrugated groove correspondingly when the output shaft is rotating, and each of the pair of steel balls protrudes from an outer surface of the output shaft and is held with the piston to drive the piston to reciprocate in the front-rear direction.

14. The electric impact hammer as claimed in claim 13, wherein the planetary carrier is engaged with the cylinder sleeve assembly to drive the cylinder sleeve assembly to rotate, the piston is engaged with an inner side of the cylinder sleeve assembly, and the piston and the cylinder sleeve assembly are configured to move only back and forth relatively, but are unable to rotate.

15. The electric impact hammer as claimed in claim 14, wherein a rotation speed of the planetary carrier is less than a rotation speed of the output shaft.
